(19) United States
(12) Patent Application Publication
(10) Pub. No.: US 2017/0060240 A1
(43) Pub. Date: Mar. 2, 2017

(54) INPUT DEVICE, DISPLAY DEVICE, AND PROGRAM

(71) Applicant: FUJITSU TEN LIMITED, Kobe-shi (JP)

(72) Inventors: Masahiro IINO, Kobe-shi (JP); Teruomi KUWANO, Kobe-shi (JP)

(73) Assignee: FUJITSU TEN LIMITED, Kobe-shi (JP)

(21) Appl. No.: 15/209,376

(22) Filed: Jul. 13, 2016

(30) Foreign Application Priority Data
Aug. 31, 2015 (JP) 2015-171008

(51) Int. Cl. G06F 3/01; G06F 3/041

(52) U.S. Cl. CPC G06F 3/016; G06F 3/0416

(57) ABSTRACT

An input device according to an embodiment includes an operation detection unit, at least one vibration element, a setting unit, and a vibration control unit. The operation detection unit detects a touch operation on an operation surface. The at least one vibration element vibrates the operation surface. The setting unit receives a setting where, at least, a content of the touch operation on the operation surface and a vibration parameter of the vibration element are associated with one another. The vibration control unit controls a vibration state of the vibration element based on the setting.

### CROSS-REFERENCE TO RELATED APPLICATION

This application is based upon and claims the benefit of priority of the prior Japanese Patent Application No. 2015-171008 filed on Aug. 31, 2015, the entire contents of which are incorporated herein by reference.

### FIELD

The embodiment discussed herein is directed to an input device, a display device, and a program.

### BACKGROUND

Conventionally, an input device has been known that provides a user with a sense of touch to inform that an input has been received. For example, an input device has been known that includes a control unit that sets a plurality of detection positions and determines pressures at such detection positions, and a vibration unit that generates a vibration with a vibration pattern that is changed in a multi-stepwise manner depending on the determined pressures (see, for example, Japanese Laid-open Patent Publication No. 2013-235614).

However, there is room for improvement of convenience of a user in a conventional input device in that a vibration pattern is identical for contents of operations.

### SUMMARY

An input device according to an aspect of an embodiment includes an operation detection unit, at least one vibration element, a setting unit, and a vibration control unit. The operation detection unit detects a touch operation on an operation surface. The at least one vibration element vibrates the operation surface. The setting unit receives a setting where, at least, a content of the touch operation on the operation surface and a vibration parameter of the vibration element are associated with one another. The vibration control unit controls a vibration state of the vibration element based on the setting.

### BRIEF DESCRIPTION OF DRAWINGS

More complete recognition of the present invention and advantage involved therewith could readily be understood by reading the following detailed description of the invention in conjunction with the accompanying drawings.

FIG. 1A, FIG. 1B, and FIG. 1C are diagrams schematically illustrating a display device according to an embodiment.

FIG. 2 is a block diagram illustrating a configuration of a display device according to an embodiment.

FIG. 3A and FIG. 3B are diagrams illustrating an example of a display device according to an embodiment.

FIG. 4 is a diagram illustrating another example of a display device according to an embodiment.

FIG. 5A and FIG. 5B are diagrams illustrating an example of an operation of a display device according to an embodiment for area designation in a map display.

FIG. 6A, FIG. 6B, FIG. 6C, FIG. 6D, and FIG. 6E are diagrams illustrating examples of an operation of an input device according to an embodiment for a gesture provided by touching an operation surface.

FIG. 7 is a flowchart illustrating steps of a setting for an input device according to an embodiment.

FIG. 8 is a flowchart illustrating steps of a process for an input device according to an embodiment.

FIG. 9 is a hardware configuration diagram illustrating an example of a computer that realizes a function of a display device according to an embodiment.

### DESCRIPTION OF EMBODIMENTS

Hereinafter, an embodiment of an input device, a display device, and a program as disclosed in the present application will be described in detail, with reference to the accompanying drawings. This invention is not limited to an embodiment illustrated below.

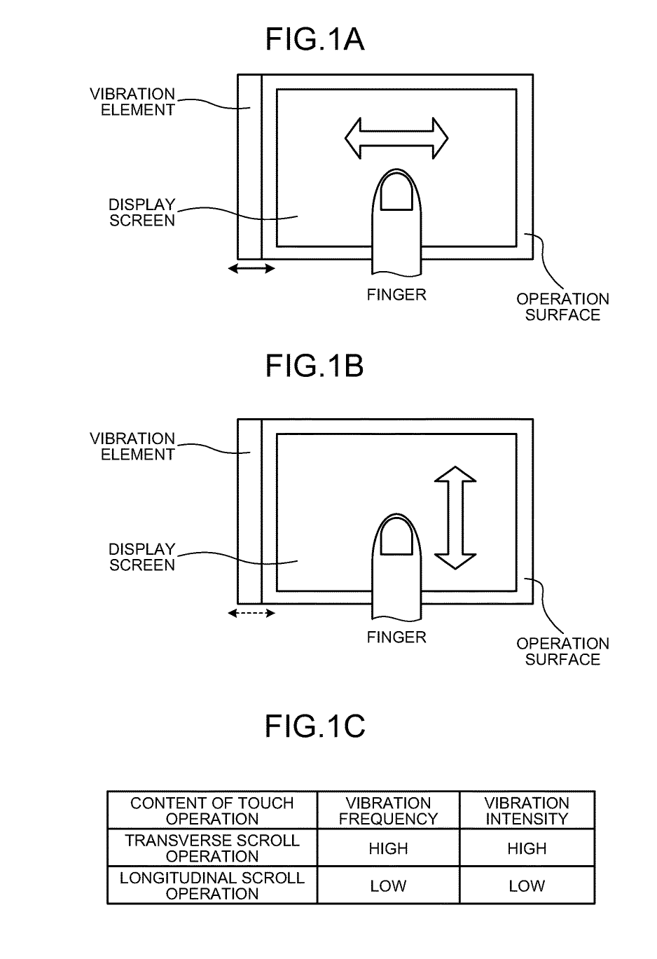

FIG. 1A, FIG. 1B, and FIG. 1C are diagrams schematically illustrating a display device according to an embodiment. As illustrated in FIG. 1A, FIG. 1B, and FIG. 1C, a display device according to an embodiment is, for example, a touch panel, and includes a panel-type input device with a vibration element (that will simply be described as an input device) and a display.

An input device has an operation surface arranged on a display screen of a display, and in a case where a touch operation of a user on the operation surface is detected, for example, an entirety or a part of an image that is displayed on the display screen of the display can be changed as a result of a process based on the touch operation of the user on the operation surface. For a touch operation on an operation surface, there is provided, for example, an operation of pressing the operation surface at a touch position on the operation surface or an operation of touching the operation surface and moving a touch position on the operation surface. A touch operation of a user on an operation surface may be, for example, an operation of moving a finger of a user that touches the operation surface.

An input device has at least one vibration element that vibrates an operation surface, and a vibration state of such a vibration element is controlled so that a user that operates the operation surface can be provided with a touch feeling based on a vibration of the vibration element.

An input device can receive an user input of a setting where, at least, a content of a touch operation of a user on an operation surface and a vibration parameter of a vibration element are associated with one another, in order to obtain a desired touch feeling based on a vibration of the vibration element. An input device can receive, for example, a setting where a direction of movement of a finger of a user that touches an operation surface and a vibration parameter of a vibration element are associated with one another. That is, a vibration state of a vibration element is controlled based on a setting that is input by a user so that a user that operates an operation surface can be provided with a predetermined touch feeling. Thus, it is possible for a user to set a vibration parameter of a vibration element that is dependent on a content of a touch operation on an operation surface so that a user that operates the operation surface obtains a predetermined touch feeling. A content of an operation includes information with respect to an operation, per se, and a result of a process based on an operation. For information with respect to an operation, per se, there is provided, for example, a period of time of a touch on an operation surface, a position of a touch on an operation surface, a direction of movement of a position of a touch on an operation surface, a velocity or an acceleration of movement of a position of a touch on an operation surface, or the like. A content of a touch operation on an operation surface may be, for example, a direction of movement of a finger of a user that touches the operation surface. For a result of a process based on an operation, there is provided, for example, a change of an entirety or a part of an image that is displayed on a display screen based on a touch operation on an operation surface or the like. For a vibration parameter of a vibration element, there is provided, for example, a vibration mode (a pattern of on/off switching of a vibration, for example, an on/off ratio of a vibration of a vibration element), a vibration intensity, a vibration frequency, a vibration position, or the like. An input device can receive, for example, a user input of a setting where an operation mode of a display device is also associated with a content of a touch operation on an operation surface and a vibration parameter of a vibration element. An input device can receive a user input of a setting where, for example, a color of a display image or a color of a display element included in a display image is associated with a content of a touch operation on an operation surface and a vibration parameter of a vibration element.

It is preferable for an input device to be able to changeably receive a user input of a setting where, at least, a content of a touch operation of a user on an operation surface and a vibration parameter of a vibration element are associated with one another. A vibration state of a vibration element is controlled based on a setting that is changeably input by an input operation of a user, and thereby, a touch feeling that is provided to a user that operates an operation surface can be adjusted. For example, it is possible for a user to repeat an input of a setting that, at least, a content of a touch operation of a user on an operation surface and a vibration parameter of a vibration element are associated with one another, in order to obtain a desired touch feeling based on a vibration of the vibration element. Thus, it is possible for a user to change a setting of a vibration parameter of a vibration element that is dependent on a content of a touch operation on an operation surface so as to obtain a desired touch feeling that corresponds to a content of the touch operation on the operation surface.

A setting will be described where a content of a scroll operation and a vibration parameter of a vibration element are associated with one another in a case where a user executes the scroll operation on an operation surface of an input device. A scroll operation refers to an operation of movement of a finger of a user for a predetermined period of time in a direction after the finger of the user touches a position on an operation surface. A transverse scroll operation refers to an operation of movement of a finger of a user for a period of time in one of transverse directions (one of leftward and rightward directions) after the finger of the user touches a position on an operation surface. A longitudinal scroll operation refers to an operation of movement of a finger of a user for a predetermined period of time in one of longitudinal directions (one of upward and downward directions) after the finger of the user touches a position on an operation surface.

FIG. 1A illustrates a case where a finger of a user touches an operation surface of an input device and subsequently the finger is transversely moved on the operation surface to scroll an image in a transverse direction (a process based on a transverse scroll operation), and FIG. 1B illustrates a case where a finger of a user touches an operation surface of an input device and subsequently the finger is longitudinally moved on the operation surface to scroll an image in a longitudinal direction (a process based on a longitudinal scroll operation).

As illustrated in FIG. 1C, an input device can preliminarily receive, and store in a table, for example, an input of a setting where a transverse scroll operation illustrated in FIG. 1A and a high vibration frequency and a high vibration intensity of a vibration element are associated with one another. An input device can preliminarily receive, and store in a table, for example, a user input of a setting where a longitudinal scroll operation illustrated in FIG. 1B and a low vibration frequency and a low vibration intensity of a vibration element are associated with one another.

In a case where a user executes a transverse scroll operation as illustrated in FIG. 1A, an input device detects that the transverse scroll operation has been executed, and retrieves a vibration frequency and a vibration intensity of a vibration element that are associated with the transverse scroll operation. An input device detects that a vibration frequency and a vibration intensity of a vibration element that are associated with a transverse scroll operation are a high vibration frequency and a high vibration intensity, respectively, and vibrates the vibration element at the high vibration frequency and the high vibration intensity.

In a case where a user executes a longitudinal scroll operation as illustrated in FIG. 1B, an input device detects that the longitudinal scroll operation has been executed, and retrieves a vibration frequency and a vibration intensity of a vibration element that are associated with the longitudinal scroll operation. An input device detects that a vibration frequency and a vibration intensity of a vibration element that are associated with a longitudinal scroll operation are a low vibration frequency and a low vibration intensity, respectively, and vibrates the vibration element at the low vibration frequency and the low vibration intensity.

Thereby, a touch feeling of an operation surface is changed depending on a content of a touch operation of a user on the operation surface, and hence, a user can recognize a content of a touch operation of the user on the operation surface so that convenience of the user can be improved.

For example, in a case where a vibration element is vibrated at an ultrasonic frequency as a high vibration frequency, a frictional force between a finger of a user and an operation surface is reduced so that an operational feeling for a transverse scroll operation can be changed. In a case where a vibration element is vibrated at a vibration frequency less than any ultrasonic frequency as a low vibration frequency, a vibration that can be recognized by a user can be provided to a finger of the user, and thereby, an operational feeling for a longitudinal scroll operation can be changed.

Thus, a display device that includes an input device according to an embodiment receives a setting where a content of a touch operation on an operation surface and a vibration parameter of a vibration element are associated with one another by an input operation of a user, and controls a vibration state of the vibration element based on such a setting, so that a predetermined touch feeling can be provided to the user. Furthermore, a user appropriately changes a setting where a content of a touch operation on an operation surface and a vibration parameter of a vibration element are associated with one another, and thereby, a touch feeling that corresponds to a touch operation on the operation surface can be adjusted appropriately.

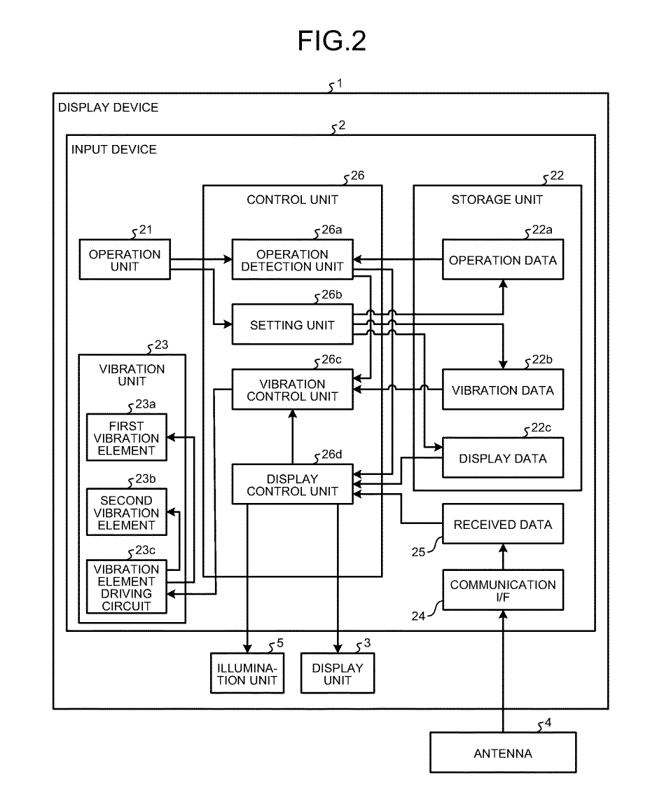

Next, a configuration of a display device 1 according to an embodiment will be described that has schematically been described by using FIG. 1A, FIG. 1B, and FIG. 1C. FIG. 2 is a block diagram illustrating a configuration of the display device 1 according to an embodiment.

The display device 1 illustrated in FIG. 2 includes an input device 2, a display unit 3, and an illumination unit 5. The input device 2 includes an operation unit 21, a storage unit 22, a vibration unit 23, a communication interface (I/F) 24, received data 25, and a control unit 26.

The storage unit 22 includes operation data 22a, vibration data 22b, and display data 22c. The control unit 26 includes an operation detection unit 26a, a setting unit 26b, a vibration control unit 26c, and a display control unit 26d. The vibration unit 23 includes a first vibration element 23a, a second vibration element 23b, and a vibration element driving circuit 23c.

The display device 1 is a device that displays an image that is controlled by the input device 2, on the display unit 3. The display device 1 is, for example, a touch panel or the like that is used for a car navigation device mounted on a vehicle, a smart phone, a tablet terminal, or the like.

The input device 2 is a device that can control image display of the display unit 3 and a vibration state of the vibration unit 23 based on an operation input through the operation unit 21. The input device 2 is, for example, a panel-type position input device that is used for a touch panel.

The operation unit 21 includes an operation surface that receives an operation input to the input device 2. The operation unit 21 is, for example, a transparent panel that detects a touch position due to a change in a electrostatic capacitance thereof, and detects an operation input to the input device 2 through an operation surface by a touch of a finger of a user, a pointing device such as a touch pen, or the like (pressure detection). A touch panel display is composed of the operation unit 21 and the display unit 3.

The storage unit 22 is composed of a storage device such as a non-volatile memory or a hard disk drive. The storage unit 22 stores the operation data 22a, the vibration data 22b, and the display data 22c as data that are used for controlling the vibration unit 23, the display unit 3, or the like, based on an operation input through the operation unit 21.

The operation data 22a are data that relate to an operation input through an operation surface of the operation unit 21. For example, the operation data 22a may be data that relate to a touch operation, per se, such as a press operation, a flick operation, an up, down, left, or right scroll operation, or a rotational operation that is executed by touching an operation surface, or may be data that relate to a result of a process based on a touch operation. A press operation refers to an operation of touching a position on an operation surface for a predetermined period of time. A flick operation refers to an operation of touching a position on an operation surface and subsequently moving such a touch position at a speed greater than or equal to a predetermined speed in one direction. Up, down, left, and right scroll operations refer to operations of touching a position on an operation surface and subsequently moving such a touch position for a predetermined period of time in upward, downward, leftward, and rightward directions, respectively. A rotational operation refers to an operation of touching a position on an operation surface and subsequently rotationally moving such a touch position for a predetermined period of time in a clockwise or counterclockwise direction on the operation surface while a point on the operation surface is a center.

The vibration data 22b are data that relate to a vibration state of the first vibration element 23a and a vibration state of the second vibration element 23b. The vibration data 22b may be, for example, data that relate to vibration parameters, such as vibration modes (patterns of switching on or off of a vibration), vibration intensities, or vibration frequencies, of the first vibration element 23a and the second vibration element 23b.

The display data 22c are data that are stored in the storage unit 22 and relate to an image that is displayed on the display unit 3. The display data 22c may be, for example, data that relate to map information produced based on a variety of traffic information or the like, data that relate to voice or video, data that relate to a photograph taken by a camera, or the like. The display data 22c include data that relate to a predetermined display element included in a display image.

The first vibration element 23a is a vibration element that vibrates at a first vibration frequency. The first vibration element 23a may be, for example, a piezoelectric element (piezo element). The first vibration element 23a may be a vibration element that vibrates at an ultrasonic frequency.

In a case where a vibration frequency of the first vibration element 23a is an ultrasonic frequency, a vibration state of the first vibration element 23a is turned on, and thereby, it is possible to reduce a fiction force on an operation surface of the operation unit 21. That is, a vibration state of the first vibration element 23a is turned on, and thereby, it is possible for an operation surface of the operation unit 21 to provide a user with a touch feeling caused by reduced friction. Furthermore, a vibration intensity of the first vibration element 23a is changed, and thereby, it is possible to change a friction force on an operation surface of the operation unit 21.

On the other hand, a vibration state of the first vibration element 23a is turned off, and thereby, an original friction force on an operation surface is reproduced. That is, a vibration state of the first vibration element 23a is turned off, and thereby, it is possible for an operation surface of the operation unit 21 to provide a user with a touch feeling caused by an original friction on the operation surface.

In a case where a vibration frequency of the first vibration element 23a is an ultrasonic frequency, a vibration state of the first vibration element 23a is switched on or off, and thereby, it is possible to change a friction force on an operation surface of the operation unit 21 repeatedly. For example, a vibration of the first vibration element 23a is switched on or off, for example, a vibration of the first vibration element 23a is switched at a constant on/off ratio, and thereby, it is possible to change a friction force on an operation surface of the operation unit 21 periodically. As a result, it is possible for an operation surface of the operation unit 21 to provide a user with, for example, a touch feeling as if there would be irregularities on the operation surface.

The second vibration element 23b is a vibration element that vibrates at a second vibration frequency different from a first vibration frequency. For example, the second vibration element 23b may be a piezoelectric element (piezo element) or may be a motor with a member that vibrates an operation surface and is provided on an output shaft thereof.

The second vibration element 23b may be a vibration element that vibrates at a vibration frequency less than a vibration frequency of the first vibration element 23a. For example, the second vibration element 23b may be a vibration element that vibrates at a frequency less than any ultrasonic frequency. In a case where the second vibration element 23b is a vibration element that vibrates at a frequency less than any ultrasonic frequency, it is possible for an operation surface of the operation unit 21 to provide a user with a touch feeling of such vibration.

The first vibration element 23a that vibrates at an ultrasonic frequency and the second vibration element 23b that vibrates at a vibration frequency less than any ultrasonic frequency are combined so that it is possible for an operation surface of the operation unit 21 to provide a user with both a touch feeling of varying friction and a touch feeling of vibration.

The vibration element driving circuit 23c is a circuit that drives the first vibration element 23a and the second vibration element 23b based on a signal output from the vibration control unit 26c.

The communication I/F 24 is connected to an antenna 4 that transmits or receives radio waves or the like, and is composed of a communication device for executing wireless communication.

The received data 25 are data received through the communication I/F 24. The received data 25 are, for example, a radio wave signal or the like.

The display unit 3 is a device that displays an image based on the display data 22c or the received data 25. The display unit 3 may be provided to be opposite to an operation surface of the operation unit 21. The display unit 3 may be provided integrally with the input device 2 or may be provided separately from the input device 2. For example, the display unit 3 may be a panel-type liquid crystal display device. For example, the display unit 3 may be configured to be translucent on a windshield part in front of a driver for a vehicle by a display such as a head-up display (HUD) or may be configured on an instrument part in front of a driver for a vehicle or a rearview mirror of a vehicle.

The illumination unit 5 illuminates an operation surface of the operation unit 21. For example, the illumination unit 5 may be a backlight device that illuminates a panel-type liquid crystal display device from a back side thereof.

The control unit 26 executes a total control of the display device 1.

The operation detection unit 26a detects an operation executed by touching an operation surface of the operation unit 21. The operation detection unit 26a reads the operation data 22a stored in the storage unit 22 and determines a content of a detected operation. The operation detection unit 26a transmits a signal that relates to a content of a detected operation, to the vibration control unit 26c and the display control unit 26d.

The setting unit 26b associates the operation data 22a and the vibration data 22b with one another and stores each of the operation data 22a and the vibration data 22b in the storage unit 22. The setting unit 26b stores data that relate to an image that is displayed on the display unit 3, as the display data 22c, in the storage unit 22. Association or storage of the operation data 22a and the vibration data 22b, storage of the display data 22c, or the like that is executed in the setting unit 26b is executed by changeably receiving an input though the operation unit 21. The setting unit 26b may associate the operation data 22a, the vibration data 22b, and the display data 22c with one another and store each of the operation data 22a, the vibration data 22b, and the display data 22c in the storage unit 22. In such a case, association or storage of the operation data 22a, the vibration data 22b, and the display data 22c, or the like that is executed in the setting unit 26b is also executed by changeably receiving an input through the operation unit 21.

The display control unit 26d receives a signal that relates to a content of an operation transmitted from the operation detection unit 26a, and transmits a signal of an image corresponding to the operation to the display unit 3 based on the display data 22c or the received data 25. The display control unit 26d transmits a signal that relates to an image corresponding to an operation to the vibration control unit 26c. The display control unit 26d transmits, to the illumination unit 5, a signal that controls the illumination unit 5 for illuminating an operation surface 21a of the operation unit 21.

The display unit 3 receives a signal of an image corresponding to an operation received from the display control unit 26d and displays an image corresponding to an operation on a display screen thereof.

The vibration control unit 26c receives a signal that relates to a content of an operation transmitted from the operation detection unit 26a and a signal that relates to an image corresponding to an operation and transmitted from the display control unit 26d, and determines whether or not a content of an operation or an image corresponding to an operation that is transmitted from the operation detection unit 26a satisfies a condition for vibrating at least one of the first vibration element 23a and the second vibration element 23b. In a case where a condition for vibrating at least one of the first vibration element 23a and the second vibration element 23b is satisfied, the vibration control unit 26c reads the vibration data 22b stored in the storage unit 22 and controls a vibration state of at least one of the first vibration element 23a and the second vibration element 23b that are included in the vibration unit 23, based on the vibration data 22b.

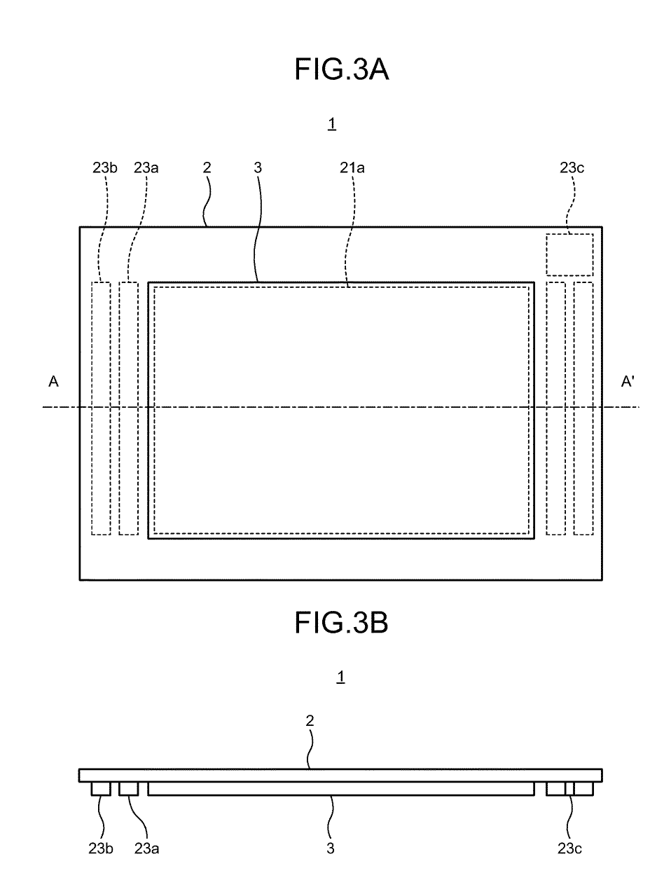

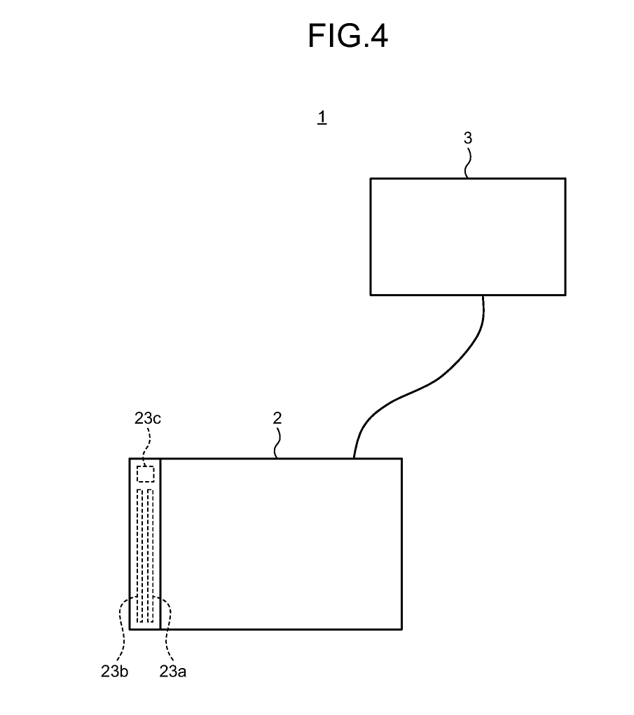

Next, examples of the display device 1 according to an embodiment that has been described by using FIG. 2 will be described by using FIG. 3A, FIG. 3B, and FIG. 4.

FIG. 3A and FIG. 3B are diagrams illustrating an example of the display device 1 according to an embodiment. FIG. 3A is a plan view of the display device 1 according to an embodiment and FIG. 3B is a cross-sectional view (cross-sectional view along A-A′ illustrated in FIG. 3A) of the display device 1 according to an embodiment. Arrangement or sizes of a first vibration element 23a and a second vibration element 23b that are illustrated in FIG. 3A and FIG. 3B is/are examples and the arrangement or sizes of the first vibration element 23a and the second vibration element 23b is/are not limited to that/those illustrated in FIG. 3A and FIG. 3B.

As illustrated in FIG. 3A and FIG. 3B, a panel-type display unit 3 is provided integrally with a panel-type input device 2 in the display device 1 according to an embodiment. The panel-type display unit 3 is provided to be opposite to an operation surface 21a of an operation unit 21 of the panel-type input device 2.

In the display device 1 illustrated in FIG. 3A and FIG. 3B, the first vibration element 23a that vibrates at a first vibration frequency and the second vibration element 23b that vibrates at a second vibration frequency different from the first vibration frequency are provided to be parallel to one side of the display unit 3 with a rectangular shape in the input device 2. Although the first vibration element 23a and the second vibration element 23b are provided to be parallel to a short side of the display unit 3 with a rectangular shape in FIG. 3A and FIG. 3B, the first vibration element 23a and the second vibration element 23b may be provided to be parallel to a long side of the display unit 3 with a rectangular shape. It is preferable to arrange the first vibration element 23a and the second vibration element 23b in such a manner that an entirety of the operation surface 21a can be vibrated uniformly. Although the vibration element driving circuit 23c is provided at one corner of the display unit 3 with a rectangular shape in the display device 1 illustrated in FIG. 3A and FIG. 3B, arrangement of the vibration element driving circuit 23c in the display device 1 is not particularly limited.

FIG. 4 is a diagram illustrating another example of the display device 1 according to an embodiment.

As illustrated in FIG. 4, the display unit 3 in the display device 1 may be provided separately from the input device 2 with the first vibration element 23a and the second vibration element 23b. The display unit 3 is configured to communicate with the input device 2. Although the input device 2 has no display function, a position on a display surface of the display unit 3 is associated with a position on an operation surface of the input device 2 in a similarity relationship (for example, as representative positions are illustrated, an upper right corner, a lower right corner, an upper left corner, a lower left corner, and a central position of the display surface of the display unit 3 correspond to an upper right corner, a lower right corner, an upper left corner, a lower left corner, and a central position of the operation surface of the input device 2, respectively).

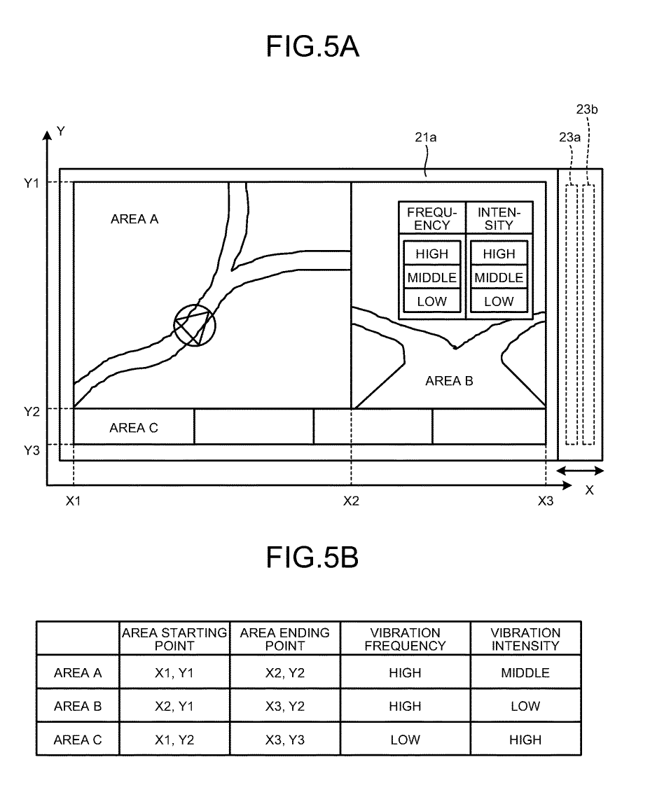

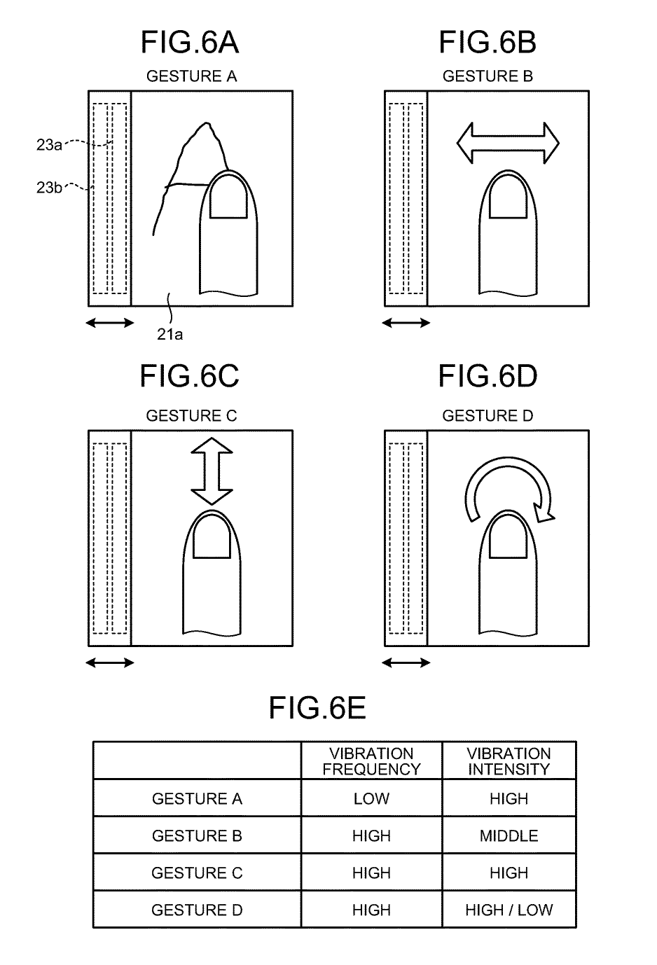

Next, an example of an operation of the display device 1 according to an embodiment that has been described by using FIG. 2 will be described by using FIG. 5A, FIG. 5B, FIG. 6A, FIG. 6B, FIG. 6C, FIG. 6D, and FIG. 6E.

FIG. 5A and FIG. 5B are diagrams illustrating an example of an operation of the display device 1 according to an embodiment for an area designation in a map display.

As illustrated in FIG. 5A and FIG. 53, the display device 1 is a display device that in used for a car navigation device and the display control unit 26d displays a navigation screen including map information on the display unit 3. That is, as illustrated in FIG. 5A and FIG. 5B, a user selects a map display mode as an operation mode of the display device 1. In such a case, a setting will be described where a content of a touch operation of a user on the operation surface 21a of the operation unit 21 and vibration parameters of the first vibration element 23a and the second vibration element 23b are associated with one another.

As illustrated in FIG. 5A, the setting unit 26b sets, as an initial setting, for example, an area A, an area B, and an area C that are rectangular areas of the operation surface 21a of the input device 2 that is divided to correspond to kinds of images that are displayed on the display unit 3. Alternatively, the setting unit 26b may receive a user input through the operation unit 21, and thereby, set the area A, the area B, and the area C that are divided rectangular areas of the operation surface 21a of the input device 2. For example, the setting unit 26b may detect a touch operation on the operation surface 21a where an outer frame for an area A, an area B, and an area C that are divided rectangular areas of the operation surface 21a is traced with a finger of a user (an operation of moving a finger of a user in a direction along each side that composes an outer frame of each of the area A, the area B, and the area C on the operation surface 21a). For example, the area A, the area B, and the area C may be a two-dimensional map display area, a three-dimensional enlarged-view display area (for example, an intersection enlarged-view display area), and a button display area, respectively. As an XY coordinate system is set on the operation surface 21a as illustrated in FIG. 5A, the area A is a rectangular area defined by an area starting point (X1, Y1) and an area ending point (X2, Y2), while the area B is a rectangular area defined by an area starting point (X2, Y1) and an area ending point (X3, Y2) and the area C is a rectangular area defined by an area starting point (X1, Y2) and an area ending point (X3, Y3). Although rectangular areas are defined on the operation surface 21a in FIG. 5A and FIG. 5B, an area with another shape such as a circular area with a central position and a radius may be defined on the operation surface 21a.

As illustrated in FIG. 5A, for example, as a user executes an operation of causing a finger to touch a position in the area A on the operation surface 21a of the input device 2 (touch operation in the area A on the operation surface 21a), the operation detection unit 26a detects that a touch operation in the area A on the operation surface 21a (designation of the area A) has been executed.

As the operation detection unit 26a detects that a touch operation in the area A on the operation surface 21a has been executed, the vibration control unit 26c vibrates a vibration element in the vibration unit 23 based on a table of vibration parameters of a vibration element that are set to be associated with a touch operation in the area A on the operation surface 21a.

For example, as illustrated in FIG. 5B, the vibration control unit 26c vibrates, for example, the first vibration element 23a at a high vibration frequency and a middle vibration intensity. In a case where a high vibration frequency is an ultrasonic frequency, a friction force between a finger of a user and the operation surface 21a can be reduced by vibrating the first vibration element 23a.

A user moves a finger on the operation surface 21a, and thereby, perceives reduction of a friction force between the finger of the user and the operation surface 21a. As a result, a user can recognize, by a touch feeling, that a touch operation is executed in the area A on the operation surface 21a.

Similarly, as the operation detection unit 26a detects that a touch operation in the area B on the operation surface 21a (designation of the area b) has been executed, the vibration control unit 26c vibrates, for example, the first vibration element 23a at a high vibration frequency and a low vibration intensity, as illustrated in FIG. 5B. In a case where a high frequency is an ultrasonic frequency, a friction force between a finger of a user and the operation surface 21a can be reduced by vibrating the first vibration element 23a. However, a vibration intensity is low, and hence, reduction of a friction force between a finger of a user and the operation surface 21a is suppressed.

A user moves a finger on the operation surface 21a, and thereby, perceives that a friction force between the finger of the user and the operation surface 21a is close to an original friction force between the finger of the user and the operation surface 21a. As a result, a user can recognize, by a touch feeling, that a touch operation has been executed in the area B on the operation surface 21a.

Similarly, as the operation detection unit 26a detects that a touch operation in the area C on the operation surface 21a (designation of the area C) has been executed, the vibration control unit 26c vibrates, for example, the second vibration element 23b at a low vibration frequency and a high vibration intensity, as illustrated in FIG. 5B. In a case where a low vibration frequency is a frequency lower than any ultrasonic frequency, a touch feeling of a vibration of the operation surface 21a can be provided to a finger of a user by vibrating the second vibration element 23b.

Hence, a user can recognize that a touch operation in the area C on the operation surface 21a has been executed, by a touch feeling of a vibration of the operation surface 21a.

The setting unit 26b can receive a setting where a touch operation in the area A on the operation surface 21a (designation of the area A) and a high vibration frequency and a middle vibration intensity of the first vibration element 23a are associated with one another by a user. Similarly, the setting unit 26b can receive a setting where a touch operation in the area B on the operation surface 21a (designation of the area B) and a high vibration frequency and a low vibration intensity of the first vibration element 23a are associated with one another by a user. The setting unit 26b can receive a setting where a touch operation in the area C on the operation surface 21a (designation of the area C) and a low vibration frequency and a high vibration intensity of the second vibration element 23b are associated with one another by a user.

Specifically, as the setting unit 26b receives, through the operation unit 21, a touch operation (designation of the area A, the area B, or the area C) in a predetermined area (the area A, the area B, or the area C) on the operation surface 21a, the display control unit 26d displays, on the display unit 3, a switch for causing a user to select an option (high, middle, or low) of a vibration frequency and an option (high, middle , or low) of a vibration intensity of a vibration element as illustrated in FIG. 5A.

For example, as the setting unit 26b receives an input of selection of an option of “high” and an option of “middle” as a vibration frequency and a vibration intensity of a vibration element that are associated with designation of the area A, respectively, from a user through the operation unit 21, the setting unit 26b stores a setting where designation of the area A as the operation data 22a and a high vibration frequency and a middle vibration frequency of the first vibration element 23a as the vibration data 22b are associated with one another. A high vibration frequency is preliminarily associated with the first vibration element 23a.

Similarly, as the setting unit 26b receives an input of selection of an option of “high” and an option of “low” as a vibration frequency and a vibration intensity of a vibration element that are associated with designation of the area B, respectively, from a user though the operation unit 21, the setting unit 26b stores a setting where designation of the area B as the operation data 22a and a high vibration frequency and a low vibration intensity of the first vibration element 23a as the vibration data 22b are associated with one another.

For example, as the setting unit 26b receives an input of selection of an option of “low” and an option of “high” as a vibration frequency and a vibration intensity of a vibration element that are associated with designation of the area C, respectively, from a user though the operation unit 21, the setting unit 26b stores a setting where designation of the area C as the operation data 22a and a low vibration frequency and a high vibration intensity of the second vibration element 23b as the vibration data 22b are associated with one another. A middle or low vibration frequency is preliminarily associated with the second vibration element 23b.

As the setting unit 26b receives a setting where a touch operation in a predetermined area (the area A, the area B, or the area C) on the operation surface 21a and a vibration frequency and a vibration intensity of the first vibration element 23a or the second vibration element 23b are associated with one another and subsequently the operation detection unit 26a detects a touch operation in a predetermined area according to a setting, the vibration control unit 26c vibrates the first vibration element 23a or the second vibration element 23b at a vibration frequency and a vibration intensity according to a setting. Thus, a user can confirm a touch feeling caused by a vibration of the first vibration element 23a or the second vibration element 23b that is associated with a touch operation in a predetermined area on the operation surface 21a.

Thus, a user can appropriately associate a touch operation in a predetermined area (designation of an area) on the operation surface 21a and a vibration frequency and a vibration intensity of the first vibration element 23a or the second vibration element 23b with one another, through the setting unit 26b. Hence, a user can adjust a touch feeling caused by a vibration of the first vibration element 23a or the second vibration element 23b for each touch operation in a predetermined area (designation of an area) on the operation surface 21a.

It is preferable for the setting unit 26b to changeably receive a setting where a touch operation in a predetermined area (designation of an area) on the operation surface 21a and a vibration frequency and a vibration intensity of the first vibration element 23a or the second vibration element 23b are associated with one another. A user can repeat a change of a setting to obtain desired touch feeling caused by a vibration of the first vibration element 23a or the second vibration element 23b.

Herein, the display control unit 26d may change a color of an image that corresponds to an area designated by a touch operation of designating a predetermined area on the operation surface 21a. In such a case, a user can visually recognize a designated area. Alternatively, the display control unit 26d may change a color or the like of illumination for the input device 2 from the illumination unit 5 provided in the display device 1 and thereby change a color of an image depending on a designated area. In such a case, a user may also be able to recognize a designated area visually.

Thus, the setting unit 26b receives a setting where a touch operation of designating a predetermined area on the operation surface 21a (designation of an area), a vibration frequency and a vibration intensity of the first vibration element 23a or the second vibration element 23b, and a color of an image corresponding to a designated area or a color of an image dependent on a designated area are associated with one another. In such a case, a user can appropriately associate, through the setting unit 26b, a touch operation in a predetermined area on the operation surface 21a (designation of an area), a vibration frequency and a vibration intensity of the first vibration element 23a or the second vibration element 23b, and a color of an image corresponding to a designated area or a color of an image dependent on a designated area with one another.

Hence, a user can associatively adjust a touch feeling caused by a vibration of the first vibration element 23a or the second vibration element 23b and a color vision caused by a color of an image corresponding to a designated area or a color of an image dependent on a designated area with one another, for each touch operation in a predetermined area on the operation surface 21a (designation of an area). For example, a user can associate a vibration frequency of the first vibration element 23a or the second vibration element 23b and a hue of a color of an image with one another. While a user can associate a relatively high vibration frequency and a warm color with one another, a user can associate a relatively low vibration frequency and a cold color with one another. For example, a user can associate a vibration intensity of the first vibration element 23a or the second vibration element 23b and a chroma or brightness of a color of an image with one another. While a user can associate a relatively high vibration intensity and a high chroma or brightness with one another, a user can associate a relatively low vibration intensity and a low chroma or brightness with one another.

As the setting unit 26b receives a setting where a touch operation in a predetermined area on the operation surface 21a (designation of an area) and a vibration frequency and a vibration intensity of the first vibration element 23a or the second vibration element 23b are associated with one another, it is preferable for the display control unit 26d to adjust a color of an image corresponding to a designated area or a color of an image dependent on a designated area or change a display format of a frame of an image corresponding to a designated area so that it is indicated that a user is designating an area. It is preferable for the display control unit 26d to determine whether or not a user has completed a setting where a touch operation in a predetermined area on the operation surface 21a (designation of an area) and a vibration frequency and a vibration intensity of the first vibration element 23a or the second vibration element 23b are associated with one another, and change a display format of an image based on a result of such determination.

FIG. 6A, FIG. 6B, FIG. 6C, FIG. 6D, and FIG. 6E are diagrams illustrating examples of an operation of the input device 2 according to an embodiment for a gesture provided by touching the operation surface 21a. A gesture (touch gesture) refers to a predetermined operation of a finger of a user that touches the operation surface 21a.

As illustrated in FIG. 6A, FIG. 6B, FIG. 6C, FIG. 6D, and FIG. 6E, the input device 2 is a position input device that is used for a smartphone or a tablet terminal. In an example illustrated in FIG. 6A, a user selects a handwritten character mode as an operation mode of the display device 1. In an example illustrated in FIG. 6B, a user selects a track-up/down mode as an operation mode of the display device 1. In an example illustrated in FIG. 6C, a user selects an album-up/down mode as an operation mode of the display device 1. In an example illustrated in FIG. 6D, a user selects a volume control mode as an operation mode of the display device 1. In such cases, a setting will be described where a content of a touch operation of a user on the operation surface 21a of the operation unit 21 and vibration parameters of the first vibration element 23a and the second vibration element 23b are associated with one another.

As illustrated in FIG. 6A, for example, as a user executes an operation of causing a finger of the user to touch a position on the operation surface 21a of the input device 2 and subsequently moving the finger of the user (in a direction of a straight line or a curved line that composes a character) so as to write a character on the operation surface 21a (a touch operation of writing a handwritten character on the operation surface 21a), the operation detection unit 26a analyzes a trajectory of the finger moved on the operation surface 21a to estimate or detect that a touch operation of writing a handwritten character on the operation surface 21a (gesture A) has been executed.

As the operation detection unit 26a estimates or detects that a touch operation of writing a handwritten character on the operation surface 21a (gesture A) has been executed, the vibration control unit 26c vibrates a vibration element in the vibration unit 23 based on a table of vibration parameters of the vibration element that are set and associated with the touch operation of writing a handwritten character on the operation surface 21a (gesture A).

For example, as illustrated in FIG. 6E, the vibration control unit 26c vibrates, for example, the second vibration element 23b at a low vibration frequency and a high vibration intensity. In a case where a low vibration frequency is a vibration frequency lower than any ultrasonic frequency, a touch feeling of vibration of the operation surface 21a can be provided to a finger of a user by vibrating the second vibration element 23b.

Hence, a user can recognize that a touch operation of writing a handwritten character on the operation surface 21a (gesture A) has been executed, by a touch feeling of a vibration of the operation surface 21a.

Similarly, as illustrated in FIG. 6B, for example, as a user executes an operation of causing a finger of the user to touch a position on the operation surface 21a of the input device 2 and subsequently moving the finger of the user in one of transverse directions on the operation surface 21a for a predetermined period of time (touch operation of moving a finger in a transverse direction on the operation surface 21a), the operation detection unit 26a analyzes a trajectory of the finger moved on the operation surface 21a to detect that a touch operation of moving a finger in a transverse direction on the operation surface 21a (gesture B) has been executed.

As the operation detection unit 26a detects that a touch operation of moving a finger in a transverse direction on the operation surface 21a (gesture B) has been executed, the vibration control unit 26c vibrates a vibration element in the vibration unit 23 based on a table of vibration parameters that are set and associated with the touch operation of moving a finger in a transverse direction on the operation surface 21a (gesture B).

For example, as illustrated in FIG. 6E, the vibration control unit 26c vibrates, for example, the first vibration element 23a at a high vibration frequency and a middle vibration intensity. Herein, in a case where a high vibration frequency is an ultrasonic frequency, a friction force between a finger of a user and the operation surface 21a can be reduced by vibrating the first vibration element 23a.

A user moves a finger on the operation surface 21a, and thereby, perceives reduction of a friction force between the finger of the user and the operation surface 21a. As a result, a user can recognize, by a touch feeling, that a touch operation of moving a finger in a transverse direction on the operation surface 21a (gesture B) has been executed.

Similarly, as illustrated in FIG. 6C, for example, as a user executes an operation of causing a finger of the user to touch a position on the operation surface 21a of the input device 2 and subsequently moving the finger of the user in one of longitudinal directions on the operation surface 21a for a predetermined period of time (touch operation of moving a finger in a longitudinal direction on the operation surface 21a), the operation detection unit 26a analyzes a trajectory of a finger moved on the operation surface 21a to detect that a touch operation of moving a finger in a longitudinal direction on the operation surface 21a (gesture C) has been executed.

As the operation detection unit 26a detects that a touch operation of moving a finger in a longitudinal direction on the operation surface 21a (gesture C) has been executed, the vibration control unit 26c vibrates a vibration element on the vibration unit 23 based on a table of vibration parameters of the vibration element that are set and associated with the touch operation of moving a finger in a longitudinal direction on the operation surface 21a (gesture C).

For example, as illustrated in FIG. 6E, the vibration control unit 26c vibrates, for example, the first vibration element 23a at a high vibration frequency and a high vibration intensity. Herein, in a case where a high vibration frequency is an ultrasonic frequency, a friction force between a finger of a user and the operation surface 21a can be reduced by vibrating the first vibration element 23a. A vibration intensity of the first vibration element 23a in the example illustrated in FIG. 6C is higher than a vibration intensity of the first vibration element 23a in the example illustrated in FIG. 6B. Hence, a friction force between a finger of a user and the operation surface 21a in the example illustrated in FIG. 6C can be further reduced as compared with that in the example illustrated in FIG. 6B.

A user moves a finger on the operation surface 21a, and thereby, perceives further reduction of a friction force between the finger of the user and the operation surface 21a. As a result, a user can recognize, by a touch feeling, that a touch operation of moving a finger in a longitudinal direction on the operation surface 21a (gesture C) has been executed.

Similarly, as illustrated in FIG. 6D, for example, as a user executes an operation of causing a finger of the user to touch a position on the operation surface 21a of the input device 2 and subsequently rotationally moving the finger of the user in a clockwise or counterclockwise direction on the operation surface 21a for a predetermined period of time while a point on the operation surface 21a is a center (touch operation of rotating a finger on the operation surface 21a), the operation detection unit 26a analyzes a trajectory of a finger moved on the operation surface 21a to estimate or detect that a touch operation of rotating a finger on the operation surface 21a (gesture D) has been executed.

As the operation detection unit 26a estimates or detects that a touch operation of rotating a finger on the operation surface 21a (gesture D) has been executed, the vibration control unit 26c vibrates a vibration element in the vibration unit 23 based on a table of vibration parameters of the vibration element that are set and associated with the touch operation of rotating a finger on the operation surface 21a (gesture D).

For example, as illustrated in FIG. 6E, the vibration control unit 26c vibrates, for example, the first vibration element 23a at a high vibration frequency and a high/low periodic vibration intensity. In a case where a high vibration frequency is an ultrasonic frequency, a friction force between a finger of a user and the operation surface 21a can be increased or decreased periodically by vibrating the first vibration element 23a.

A user moves a finger on the operation surface 21a, and thereby, perceives a periodic increase or decrease of a friction force between the finger of the user and the operation surface 21a. A periodic increase or decrease of a friction force between a finger of a user and the operation surface 21a can provide a user with a touch feeling as if there would be irregularities on the operation surface 21a. As a result, a user can recognize, by a touch feeling, that a touch operation of rotating a. finger on the operation surface 21a (gesture D) has been executed.

The setting unit 26b can receive a setting where a touch operation of writing a handwritten character on the operation surface 21a (gesture A) and a low vibration frequency and a high vibration intensity of the second vibration element 23b are associated with one another by a user. Similarly, the setting unit 26b can receive a setting where a touch operation of moving a finger in a transverse direction on the operation surface 21a (gesture B) and a high vibration frequency and a middle vibration intensity of the first vibration element 23a are associated with one another by a user. The setting unit 26b can receive a setting where a touch operation of moving a finger in a longitudinal direction on the operation surface 21a (gesture C) and a high vibration frequency and a high vibration intensity of the first vibration element 23a are associated with one another by a user. The setting unit 26b can receive a setting where a touch operation of rotating a finger on the operation surface 21a (gesture D) and a high vibration frequency and a high/low periodic vibration intensity of the first vibration element 23a are associated with one another by a user.

Thus, a user can appropriately associate a touch operation of moving a finger on the operation surface 21a (gesture) and a vibration frequency and a vibration intensity of the first vibration element 23a or the second vibration element 23b with one another, through the setting unit 26b. Hence, a user can adjust a touch feeling caused by a vibration of the first vibration element 23a or the second vibration element 23b for each touch operation of moving a finger on the operation surface 21a (gesture).

It is preferable for the setting unit 26b to changeably receive a setting where a touch operation of moving a finger on the operation surface 21a (gesture) and a vibration frequency and a vibration intensity of the first vibration element 23a or the second vibration element 23b are associated with one another. A user can repeat a setting in order to obtain a desired touch feeling caused by a vibration of the first vibration element 23a or the second vibration element 23b.

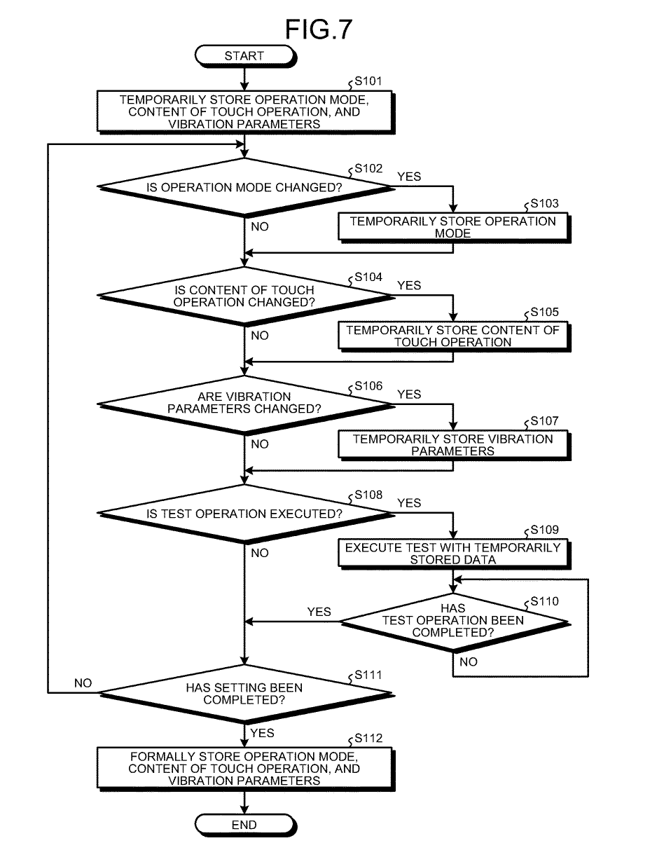

Next, a detail of steps of a setting for the input device 2 according to an embodiment will be described by using FIG. 7. FIG. 7 is a flowchart illustrating steps of a setting for the input device 2 according to an embodiment.

As illustrated in FIG. 7, at step S101, the setting unit 26b associates with one another, and temporarily stores in the storage unit 22, an operation mode of the display device 1 that is input to the input device 2 through the operation unit 21, a content of a touch operation on the operation surface 21a in such an operation mode (for example, a direction of movement of a finger of a user that touches the operation surface 21a), and vibration parameters of the first vibration element 23a and the second vibration element 23b. The setting unit 26b stores, as the operation data 22a, an operation mode of the display device 1 and a content of a touch operation on the operation surface 21a. The setting unit 26b stores, as the vibration data 22b, vibration parameters of the first vibration element 23a and the second vibration element 23b.

At step S102, the setting unit 26b receives determination as to whether or not a user changes a temporarily stored operation mode, through the operation unit 21. In a case where a user changes a temporarily stored operation mode (step S102: Yes), a process for the input device 2 goes to step S103. On the other hand, in a case where a user does not change a temporarily stored operation mode (step S102: No), a process for the input device 2 goes to step S104.

At step S103, the setting unit 26b receives an operation mode having been changed by a user through the operation unit 21, and stores the operation mode having been changed by a user as the operation data 22a. Herein, an operation mode having been changed by a user is associated with a content of a touch operation stored as the operation data 22a and vibration parameters stored as the vibration data 22b. Subsequently, a process for the input device 2 goes to step S104.

At step S104, the setting unit 26b receives determination as to whether or not a user changes a temporarily stored content of a touch operation, through the operation unit 21. In a case where a user changes a temporarily stored content of a touch operation (step S104: Yes), a process for the input device 2 goes to step S105. On the other hand, in a case where a user does not change a temporarily stored content of a touch operation (step S104: No), a process for the input device 2 goes to step S106.

At step S105, the setting unit 26b receives a content of a touch operation having been changed by a user (for example, a direction of movement of a finger of a user that touches the operation surface 21a), through the operation unit 21, and stores the content of a touch operation having been changed by a user, as the operation data 22a. A content of a touch operation having been changed by a user is associated with an operation mode stored as the operation data 22a and vibration parameters stored as the vibration data 22b. Subsequently, a process for the input device 2 goes to step S106.

At step S106, the setting unit 26b receives determination as to whether or not a user changes temporarily stored vibration parameters, through the operation unit 21. In a case where a user changes temporarily stored vibration parameters (step S106: Yes), a process for the input device 2 goes to step S107. On the other hand, in a case where a user does not change temporarily stored vibration parameters (step S106: No), a process for the input device 2 goes to step S108.

At step S107, the setting unit 26b receives vibration parameters having been changed by a user, through the operation unit 21, and stores the vibration parameters having been changed by a user as the vibration data 22b. Herein, vibration parameters having been changed by a user are associated with an operation mode stored as the operation data 22a and a content of a touch operation. Subsequently, a process for the input device 2 goes to step S108.

At step S108, the setting unit 26b receives, through the operation unit 21, determination as to whether or not a user executes a test operation for a control of vibration states of the first vibration element 23a and the second vibration element 23b based on an operation mode, a content of a touch operation, and vibration parameters that have been stored temporarily. In a case where a user executes a test operation (step S108: Yes), a process for the input device 2 goes to step S109. On the other hand, in a case where a user does not execute a test operation (step S108: No), a process for the input device 2 goes to step S111.

At step S109, the setting unit 26b and the vibration control unit 26c execute a test operation for a control of vibration states of the first vibration element 23a and the second vibration element 23b based on an operation mode, content of a touch operation, and vibration parameters that have been stored temporarily. Subsequently, a process for the input device 2 goes to step S110.

At step S110, the setting unit 26b receives determination as to whether or not a test operation has been completed, through the operation unit 21. In a case where a test operation has been completed (step S110: Yes), a process for the input device 2 goes to step S111. In a case where a test operation has not been completed (step S110: No), the input device 2 waits until the test operation is completed.

At step S111, the setting unit 26b receives determination as to whether or not a setting of an operation mode, a content of a touch operation, and vibration parameters has been completed, through the operation unit 21. For example, the setting unit 26b can display a completion switch on the display unit 3 though the display control unit 26d that refers to the display data 22c, and thereby, receive an input from a user as to whether or not a setting has been completed. Herein, the setting unit 26b may determine that a setting has been completed, in a case where there is no input from a user as to whether or not a setting has been completed, for a predetermined period of time or longer. In a case where a setting has been completed (step S111: Yes), a process for the input device 2 goes to step S112. In a case where a setting has not been completed (step S111: No), the input device 2 repeats step S102 to step S111.

At step S112, the setting unit 26b causes an operation mode, a content of a touch operation, and vibration parameters that have been stored temporarily to be an operation mode, a content of a touch operation, and vibration parameters that are stored formally.

Thus, the input device 2 can associate with one another, and changeably set, an operation mode, a content of a touch operation on the operation surface 21a, and vibration parameters of the first vibration element 23a and the second vibration element 23b. Thereby, a user can appropriately set vibration states of the first vibration element 23a and the second vibration element 23b that correspond to a touch operation on the operation surface 21a in a predetermined operation mode of the display device 1. As a result, a user can obtain a desired touch feeling for a touch operation on the operation surface 21a in a predetermined operation mode of the display device 1.

The setting unit 26b may receive a setting where an operation mode of the display device 1 and a content of a touch operation on the operation surface 21a as the operation data 22a, vibration parameters of the first vibration element 23a and the second vibration element 23b as the vibration data 22b, and the display data 22c that are input through the operation unit 21 are associated with one another. For example, the display data 22c that are input through the operation unit 21 may include data that relate to a color of a display image that is displayed on the display unit 3 or a color of a display element included in a display image that is displayed on the display unit 3. Thereby, a user can appropriately set vibration states of the first vibration element 23a and the second vibration element 23b that correspond to a touch operation on the operation surface 21a in a predetermined operation mode of the display device 1 and a color of a display image that is displayed on the display unit 3 or a color of a display element included in a display image that is displayed on the display unit 3. As a result, a user can obtain a desired touch feeling and a desired color vision for a touch operation on the operation surface 21a in a predetermined operation mode of the display device 1.

Furthermore, the setting unit 26b may receive a setting where a touch operation of moving a finger on the operation surface 21a (gesture) and a vibration frequency and a vibration intensity of the first vibration element 23a or the second vibration element 23b are associated with one another, independently of an operation mode of the display device 1. Thereby, a user can appropriately set vibration states of the first vibration element 23a and the second vibration element 23b that correspond to a touch operation on the operation surface 21a, independently of an operation mode of the display device 1. As a result, a user can obtain a desired touch feeling for a touch operation on the operation surface 21a, independently of an operation mode of the display device 1.

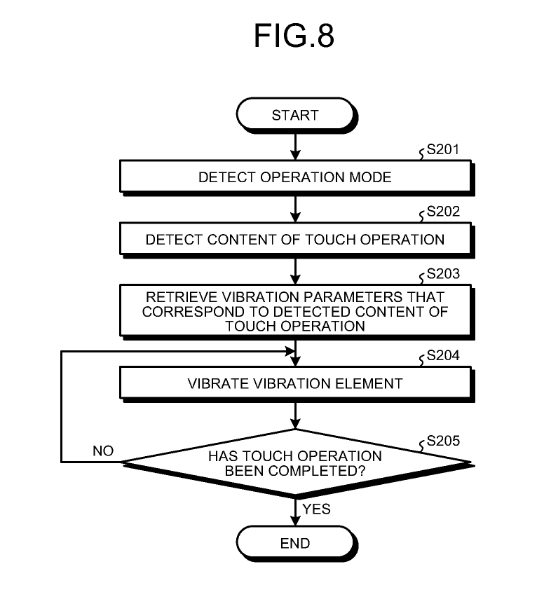

Next, a detail of steps of a process for the input device 2 according to an embodiment will be described by using FIG. 8. FIG. 8 is a flowchart illustrating steps of a process for the input device 2 according to an embodiment.

As illustrated in FIG. 8, at step S201, the operation detection unit 26a detects an operation mode of the display device 1 that is input to the input device 2 through the operation unit 21.

At step S202, the operation detection unit 26a detects a content of a touch operation on the operation surface 21a (for example, a direction of movement of a finger of a user on the operation surface 21a) in a detected operation mode with reference to the operation data 22a. The operation detection unit 26a transmits a detected content of a touch operation in a detected operation mode to the vibration control unit 26c.

At step S203, the vibration control unit 26c retrieves vibration parameters of the first vibration element 23a and the second vibration element 23b that are associated with a detected content of a touch operation in a detected operation mode, with reference to the vibration data 22b associated with the operation data 22a.

At step S204, the vibration control unit 26c vibrates the first vibration element 23a and the second vibration element 23b based on retrieved vibration parameters of the first vibration element 23a and the second vibration element 23b.

At step S205, the operation detection unit 26a receives determination as to whether or not a user has completed a touch operation on the operation surface 21a, through the operation unit 21. In a case where a user has completed a touch operation on the operation surface 21a (step S205: Yes), a process for the input device 2 is ended. On the other hand, in a case where a user has not completed a touch operation on the operation surface 21a (step S205: No), the input device 2 repeats step S204 and step S205.

Herein, the setting unit 26b may receive a setting where an operation mode of the display device 1 and a content of a touch operation on the operation surface 21a as the operation data 22a, vibration parameters of the first vibration element 23a and the second vibration element 23b as the vibration data 22b, and the display data 22c are associated with one another. The vibration control unit 26c receives a signal of an image display from the display control unit 26d that refers to the display data 22c or the like. The vibration control unit 26c can control vibration states of the first vibration element 23a and the second vibration element 23b, for example, in a case where an image display that changes based on a content of a touch operation that is received from the operation detection unit 26a satisfies a predetermined condition. In a case where the display data 22c include data that relate to a color of a display image that is displayed on the display unit 3 or a color of a display element included in a display image that is displayed on the display unit 3, the vibration control unit 26c can vibrate the first vibration element 23a and the second vibration element 23b based on vibration parameters that are associated with a color of a display image that is displayed on the display unit 3 or a color of a display element included in a display image that is displayed on the display unit 3.

In a case where the setting unit 26b receives a setting where a touch operation of moving a finger on the operation surface 21a (gesture) and a vibration frequency and a vibration intensity of the first vibration element 23a or the second vibration element 23b are associated with one another, independently of an operation mode of the display device 1, the input device 2 can omit a step of detecting the operation mode as indicated at step S201.

A program can also be provided that causes a computer to execute steps of a process for the display device 1 according to the above-mentioned embodiment. A computer-readable recording medium with the above-mentioned program stored therein can also be provided.

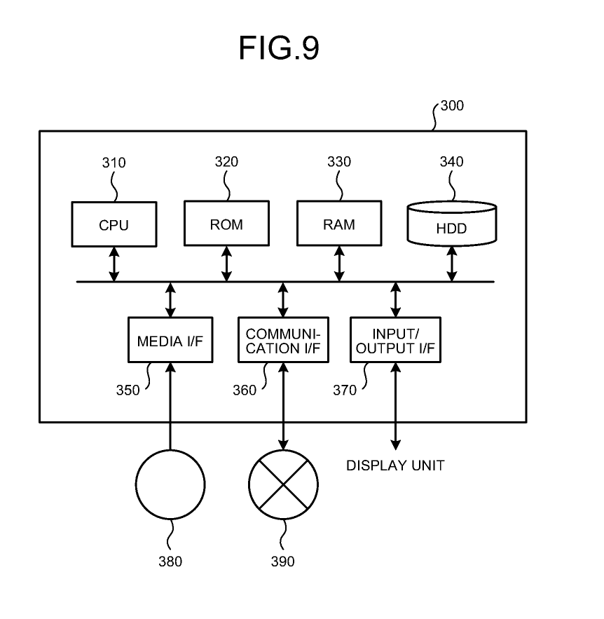

The display device 1 according to an embodiment can be realized by a computer 300 with a configuration illustrated in FIG. 9 as an example. FIG. 9 is a hardware configuration diagram illustrating an example of a computer that realizes a function of the display device 1.

The computer 300 includes a Central Processing Unit (CPU) 310, a Read Only Memory (ROM) 320, a Random Access Memory (RAM) 330, and a Hard Disk Drive (HDD) 340. The computer 300 includes a media interface (I/F) 350, a communication interface (I/F) 360, and an input/output interface (I/F) 370.

Herein, the computer 300 includes a Solid State Drive (SSD), and such an SSD may execute a part or all of functions of the HDD 340. The SSD may be provided instead of the HDD 340.

The CPU 310 operates based on a program that is stored in at least one of the ROM 320 and the HDD 340, and executes a control of each unit. The ROM 320 stores a boot program that is executed by the CPU 310 at a time of start-up of the computer 300, a program dependent on hardware of the computer 300, or the like. The HDD 340 stores a program that is executed by the CPU 310 and data that are used for such a program or the like.

The media I/F 350 reads, and provides to the CPU 310 through the RAM 330, a program or data stored in a storage medium 380. The CPU 310 loads such a program into the RAM 330 from the storage medium 380 through the media I/F 350, and executes such a loaded program. Alternatively, the CPU 310 uses such data to execute a program. The storage medium 380 is, for example, a magneto-optical recording medium such as a Digital Versatile Disc (DVD), an SD card, a USB memory, or the like.

The communication I/F 360 receives, and sends to the CPU 310, data from another instrument through a network 390, and transmits data generated by the CPU 310 to another instrument though the network 390. Alternatively, the communication I/F 360 receives, and sends to the CPU 310, a program from another instrument thought the network 390, and the CPU 310 executes such a program.

The CPU 310 controls a display unit such as a display, an output unit such as a speaker, an input unit such as a keyboard, a mouse, a button, or the operation unit 21, through the input/output I/F 370. The CPU 310 acquires data from the input unit through the input/output I/F 370. Furthermore, the CPU 310 outputs generated data to the display unit or the output unit through the input/output I/F 370.

For example, in a case where the computer 300 functions as the display device 1, the CPU 310 of the computer 300 executes a program loaded into the RAM 330 and thereby realizes each function of the control unit 26 of the input device 2 that includes the operation detection unit 26a, the setting unit 26b, the vibration control unit 26c, and the display control unit 26d.

Although the CPU 310 of the computer 300 reads from the storage medium 380, and executes, for example, such a program, such a program may be acquired from another device through the network 390, as another example. The HDD 340 can store information stored in the storage unit 22.

The input device may operate or call a predetermined function of the display device according to a content of a touch operation on the operation surface of the operation unit independently of an operation mode of the display device. The operation detection unit detects a content of a touch operation on the operation surface by analysis of a trajectory of a finger of a user on the operation surface. As a result, an AM radio may be started up by, for example, a touch operation of a user that moves a finger of the user so as to write a character “A” on the operation surface as illustrated in FIG. 6A. Furthermore, a track-up/down or album-up/down function may be called by a flick operation of a user that moves a finger of the user at a speed greater than or equal to a predetermined speed in one of transverse or longitudinal directions on the operation surface as illustrated in FIG. 6B or FIG. 6C. A dial for controlling volume of a speaker may be displayed by an operation of a user that rotationally moves a finger of the user in a clockwise or counterclockwise direction for a predetermined period of time while a point on the operation surface is center, as illustrated in FIG. 6D. In such a case, a function of the display device is operated or called independently of an operation mode of the display device, and hence, an operation or a call of a function of the display device can be executed more quickly and directly. A vibration state of a vibration element may be controlled depending on such an operation or a call of a function of the display device so as to provide a user with a particular touch feeling. It is not necessary to provide a dedicated hard switch for an operation or a call of a function of the display device.

For example, in a case where the input device receives an input operation of executing a volume control of a speaker or a temperature control of an air-conditioning machine, a sense of touch that is provided to a user may be changed depending on such volume or temperature. For example, in a case where a user executes a volume control of a speaker or a temperature control of an air-conditioning machine, the vibration control unit may periodically switch vibration frequencies of a vibration element included in the vibration unit, within a range of ultrasonic frequencies. Thereby, a magnitude of a friction force between a user and the operation surface can be increased or decreased periodically. In such a case, a user can be provided with a sense of touch as if there would be irregularities on the surface. Thereby, a user can be provided with a sense of touch dependent on an increase or decrease of volume of a speaker or a rise or a drop in set temperature of an air-conditioning machine. For example, a switching frequency of a vibration frequency may be increased with increasing volume of a speaker or raising set temperature of an air-conditioning machine. On the other hand, a switching frequency of a vibration frequency may be decreased with decreasing volume of a speaker or lowering set temperature of an air-conditioning machine.

Although an example where a shape of the operation surface of the operation unit is planar has been described in the embodiment described above, a shape of the operation surface of the operation unit may be, for example, a shape that has a curved surface. In such a case, the vibration control unit may change a vibration state of a vibration element that is included in the vibration unit depending on a shape of the operation surface and a touch position of a user on the operation surface. Thereby, a sense of touch that is provided to a user can be changed depending on a shape of the operation surface and a touch position of a user on the operation surface.

In a case where a user executes an input operation for the input device of the display device as a touch panel that is used for a car navigation device and the user is gazing at the display unit or an obstacle approaches a vehicle, a vibration state of a vibration element may be changed so as to notify the user of danger. Approach of an obstacle to a vehicle is determined by using a result of detection by a proximity sensor mounted on the vehicle. Furthermore, gazing at the display unit by a user is determined by executing detection of a line of sight of the user based on a captured image that is acquired by an image-capturing device.

In a case where the operation detection unit determines that a user has touched the operation surface for a predetermined period of time or longer, the display control unit may display a predetermined operation menu button depending on a result of such determination. Such an operation menu button is, for example, a circular button, and an image is arranged that indicates an operation of receiving an input along a circumference thereof. A user moves a touch position, for example, along an outer circumference of an operation menu button, to select an operation. While a circular button rotates according to a touch operation of a user, a vibration element that vibrates at an ultrasonic frequency is switched on or off at a predetermined frequency, and thereby, a magnitude of a friction force between a finger of the user and the operation surface is switched. Thereby, a sense of touch of irregularities is provided to a user, so that a sense of touch can be provided as if a dial would be turned actually.

In a case where an input operation such that cancellation of such an operation cannot be allowed once the operation is executed, for example, compete deletion of a file or the like, is received, the input device may provide a sense of touch for a caution such that such an input operation cannot be canceled to restore a former state once it is received. For example, as a touch position of a user approaches a button that receives an operation that cannot be canceled, an intensity of a vibration element that vibrates at an ultrasonic frequency may be reduced so as to increase a friction force of the operation surface.

For example, in a case where a user increases volume of a speaker or raises set temperature of an air-conditioning machine, a user may be provided with a sense of touch of convexity as if the operation surface would have a bulge, or in a case where volume of a speaker is decreased or set temperature of an air-conditioning machine is lowered, a user may be provided with a sense of touch of concavity as if the operation surface would have a recess. Thereby, a user can recognize, by a sense of touch, what operation is executed.

According to an aspect of an embodiment, convenience of a user can be improved by executing a control while a content of a touch operation of such a user on an operation surface and a vibration parameter of a vibration element are associated with one another. For example, an input device, a display device, and a program can be provided that can improve convenience of a user by executing a control while a content of a touch operation of such a user on an operation surface and a vibration parameter of a vibration element are associated with one another.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An input device, comprising:
an operation detection unit that detects a touch operation on an operation surface;
at least one vibration element that vibrates the operation surface;
a setting unit that receives a setting where, at least, a content of the touch operation on the operation surface and a vibration parameter of the vibration element are associated with one another; and
a vibration control unit that controls a vibration state of the vibration element based on the setting.

2. The input device according to claim 1, wherein the setting unit receives a setting where a content of the touch operation on the operation surface, a vibration parameter of the vibration element, and a color of a display image or a color of a display element included in a display image are associated with one another.

3. The input device according to claim 1, wherein the setting unit receives the setting changeably.

4. The input device according to claim 1, wherein the vibration parameter of the vibration element is at least one of an on/off ratio of a vibration of the vibration element, a vibration frequency of the vibration element, and a vibration intensity of the vibration element.

5. The input device according to claim 1, wherein:
the vibration element includes a first vibration element that vibrates at a first vibration frequency and a second vibration element that vibrates at a second vibration frequency different from the first vibration frequency; and
the setting unit receives a setting where a content of the touch operation on the operation surface and a vibration parameter of at least one of the first vibration element and the second vibration element are associated with one another.

6. The input device according to claim 1, wherein the touch operation on the operation surface is an operation of pressing the operation surface at a touch position on the operation surface.

7. The input device according to claim 1, wherein the touch operation on the operation surface is an operation of touching the operation surface and moving a touch position on the operation surface.

8. A display device, comprising:
the input device according to claim I; and
a display unit that is arranged to be opposite to the operation surface and displays an image.

9. A non-transitory computer readable medium that stores a program that causes a computer to execute, at least:
detecting a touch operation on an operation surface;
vibrating the operation surface by using at least one vibration element;
receiving a setting where, at least, a content of the touch operation on the operation surface and a vibration parameter of the vibration element are associated with one another; and
controlling a vibration state of the vibration element based on the setting.

10. An input device, comprising:
an operation detection unit that detects a touch operation of a user on an operation surface;
at least one vibration element that vibrates the operation surface;
a setting unit that receives a setting where, at least, a direction of movement of a finger of the user that touches the operation surface and a vibration parameter of the vibration element are associated with one another; and
a vibration control unit that controls a vibration state of the vibration element based on the setting.
